(19) United States
(12) Patent Application Publication
(10) Pub. No.: US 2002/0000526 A1
(43) Pub. Date: Jan. 3, 2002

(54) YARN SENSOR

(76) Inventors: EDWARD J. DELAWSKI, WILMINGTON, DE (US); JOHN C. MODLA, HOCKESSIN, DE (US)

Correspondence Address: E I DU PONT DE NEMOURS AND COMPANY, LEGAL PATENTS, WILMINGTON, DE, 19898

(21) Appl. No.: 09/290,153

(22) Filed: Apr. 13, 1999

Related U.S. Application Data
(60) Provisional application No. 60/081,669, filed on Apr. 14, 1998.

(51) Int. Cl. G01V 8/00

(52) U.S. Cl. 250/559.4

(57) ABSTRACT

A sensor for monitoring a yarn parameter, such as degree of interlace, operates by transmitting radiation from a transparent wear surface to a detector. The yarn contacts the wear surface as that the moving yarn continuously wipes the wear surface clean. A hinge assembly, including a pin, may be used with this sensor, where the pin swings toward the moving yarn to keep the yarn in contact with the wear surface.

This application claims benefit of priority from Provisional Application No. 60/081,669, filed Apr. 14, 1998.

### BACKGROUND OF THE INVENTION

In the production of yarns, yarn cohesion is obtained by, for example, twisting, or by intermingling or interlacing the individual filaments in jet nozzles. Interlacing is a particularly economical measure. However, it does not produce completely uniform yarn cohesion over the entire length of the yarn, but, rather, leads to the formation of individual, more or less regularly spaced apart, intermingled sections where the filaments are closely entangled together, and looser, bulkier, sections of low yarn cohesion. This structure on the one hand confers a particular textile overall appearance on the yarns, but on the other also affects their further processibility.

The prerequisite for any non-damaging and problem-free further processing of interlaced yarns is that the interlaced sections are sufficiently close together. Missing interlaced sections have an adverse, and in certain circumstances, even catastrophic, effect on fabric quality and loom. It is therefore of particular importance to monitor the uniformity of the interlacing continuously.

Various yarn properties have been measured on-line in the past. Of particular interest is a sensor previously developed which measures the interlace in a yarn. Such a sensor is shown at 10 in FIG. 1. Sensor 10 comprises a housing 12 in which electronics are contained, and which has front and back faces. The back face is mounted to a spinning machine. On the front face is mounted a front face assembly 14 which holds a top and a bottom grooved ceramic pin 22, 26, respectively. There is an opposing face plate 16 on which are attached additional grooved ceramic pins 21, 25, positioned so that the grooves on these pins are aligned with those mounted directly on the front face of housing 12. A hinge assembly 18 allows an opposing face plate 16 to swing both toward and away from front face assembly 14. Alignment of the grooved ceramic pins is assisted by a clasp assembly 29, 40. Moving yarns 24 are held in place when opposing face plate 16 is swung against front face assembly 14, and clasp assembly 29, 40 is engaged.

Between grooved ceramic pins 21, 25 of opposing face plate 16 are radiation sources 36 used to transmit radiation to the yarn through transparent quartz window 34. There is one radiation source for each moving yarn. The radiation passes through moving yarns 24 and through slit/window assembly 42 in the front face, where it enters detectors in housing 12 used to measure the presence or absence of the desired yarn parameter. For instance, if it is desired to measure interlace, this parameter is measured by evaluating the amount of light transmitted from a radiation source through the yarn to a sensing element using electric wires. Data from the sensor are transmitted to a control system and processed and summarized appropriately for evaluation. A drawback to this system, because it used electric wires, necessitated using two separate cable ends.

Moreover, with this system, the yarn was held mechanically between two opposing plates with grooved ceramic pins attached thereto. Alignment of the moving yarn was critical, and difficult to achieve. Also, the moving yarns were prone to break as they passed between the pins. Additionally, because the sensor had these two opposing plates, the cables in which the electric wires used to deliver radiation and carry signals back to the detector were constantly being flexed as the spinning machine was being strung up, thus subjecting the wires to premature failure.

Moreover, this prior art sensor had a transparent quartz window which served only to protect the light sources. Dirt and other contaminants collected regularly on the surface of this quartz window, thus reducing the level of transmitted radiation seen by the moving threadline.

On-line monitoring of interlace is known in the industry. See Hinchliffe, “Second Generation On-Line Monitoring: The Next Step in Automation”, IFJ, Oct, 1997, pp. 56 and 57. Also, optical sensors are known. See Japanese Kokai No. Hei 2(1990)-33342 also discloses an optical sensor. Japanese Patent Applications Publication Kokai 64-61531 and 64-61532 both disclose a method of evaluating the entanglement intensity of entangled yarn. However, both of these publications stress that the yarn must pass in a no-contact mode with the analyzing device. U.S. Pat. No. 5,140,852 to Bonigk et al. discloses a process and apparatus for measuring the degree of filament intermingling of a multifilament yarn. This process and apparatus require a sensor which examines the yarn without contact. U.S. Pat. No. 4,990,793 to Bonigk et al. also discloses a process and apparatus for measuring the degree of intermingling of a multifilament yarn, where there is contact between the yarn and a yarn transport support.

In light of the drawbacks of the prior art, it would be advantageous to have an on-line sensor for monitoring interlace, as well as other parameters, which sensor also wipes the wear surface clean.

### SUMMARY OF THE INVENTION

In accordance with the present invention, there is provided a method and an apparatus for monitoring a particular yarn parameter, such as interlace.

The method of this invention comprises the steps of transmitting a radiation from a source to a wear surface which is transparent to the radiation, contacting the wear surface with a moving yarn to be monitored so that the yarn continuously wipes the wear surface, reflecting the radiation from the yarn to a detector, and processing the reflected radiation to monitor a desired yarn parameter.

The sensor of this invention comprises a radiation source for transmitting radiation, a radiation transparent wear surface for receiving a moving yarn at which radiation is directed from the radiation source and from which radiation is reflected, and a detector for receiving the reflected radiation. The sensor of the present invention may also include a mounting plate for attaching the detector to a spinning machine, a plurality of brackets mounted on the mounting plate, each bracket holding a first guide pin for guiding a moving yarn, and a hinge assembly mounted to the mounting plate for holding a second guide pin wherein the second guide pin swings toward the moving yarn to keep the moving yarn in contact with the wear surface.

### BRIEF DESCRIPTION OF THE DRAWINGS

FIG. 1 is an elevational schematic view of a sensor of the prior art.

FIG. 2 is an elevational schematic view of the sensor of the present invention.

FIG. 3 is a partial cross-sectional view of the sensor shown in FIG. 1, taken across lines 3-3 of FIG. 2.

FIG. 4 is a plan view of the source/detector unit and the sensor of this invention.

FIG. 5 is a schematic view of an alternative wear surface useful with the present invention.

FIGS. 6A and 6B are schematic representations of differential radiation reflectances in use of this invention.

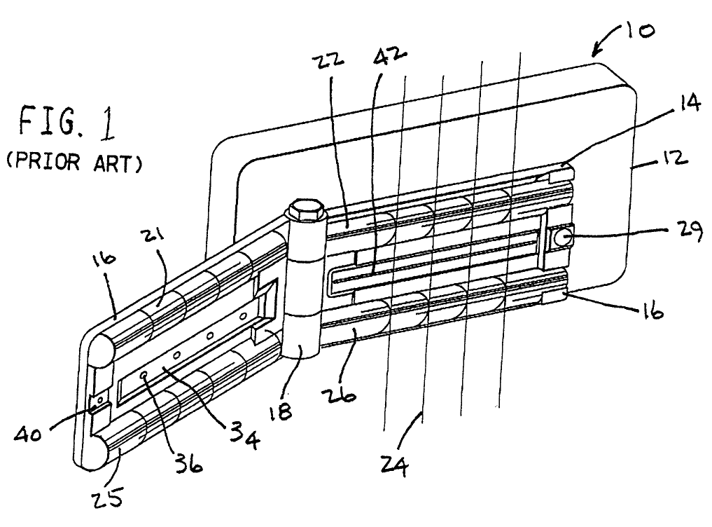

### DETAILED DESCRIPTION OF THE INVENTION

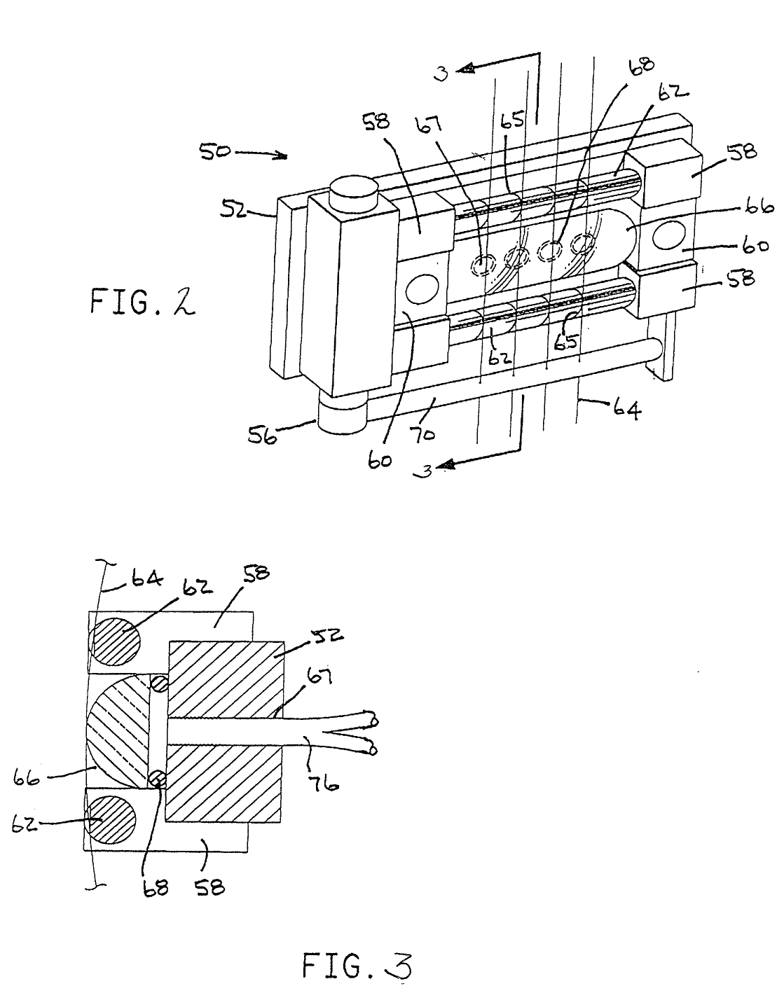

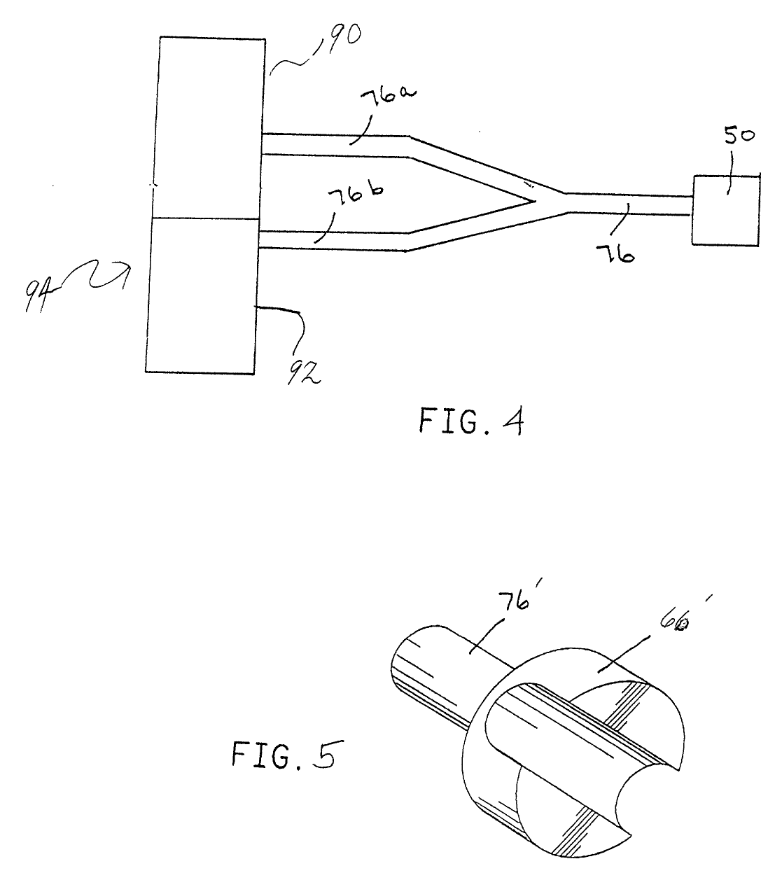

In accordance with the present invention, there is provided a sensor for monitoring a yarn parameter. A first embodiment of the sensor of the present invention is illustrated in FIGS. 2-4. The sensor is shown generally at 50 in FIGS. 2 and 4. The sensor includes a wear surface 66 as shown in FIGS. 2 and 3. The yarn, or thread line, illustrated at 64 in FIGS. 2 and 3, continuously contacts wear surface 66. In the embodiment of FIGS. 2-4, the wear surface has a half-rod shape and covers a series of sensor ports. Preferably, the wear surface is a sapphire rod.

The sensor includes a radiation source 90 as shown in FIG. 4, for transmitting radiation and a detector 92 as shown in FIG. 4. Both radiation source 90 and detector 92 are housed in a source/detector unit 94. As also shown in FIG. 4, a bifurcated cable 76 is connected to sensor 50. The bifurcated cable splits into two fiber optic bundles, 76a and 76b, which are connected to the source/detector unit. Radiation is sent through fiber optic bundle 76a to the wear surface, and is reflected from the wear surface and returns through fiber optic bundle 76b. The source/detector unit of the present invention may be disposed either at a spinning machine, or, as shown in FIG. 4, remote from the wear surface, for example, up to 20 feet away. Moreover, with the embodiment of the present invention which is shown in FIG. 4, radiation source 90 and detector 92 are located on the same side of moving yarn 64.

Wear surface 66 is transparent to the radiation. By “transparent” is meant that the radiation is not absorbed by the wear surface material, but rather the radiation is transmitted through to the yarn surface as it passes over the wear surface. Thus, the radiation may be reflected and subsequently fed to a radiation collection system, e.g., a computer. The difference between the transmitted and reflected radiation is calculated. This difference can be used to calculate pertinent parameters, such as degree of interlace, and reported as desired.

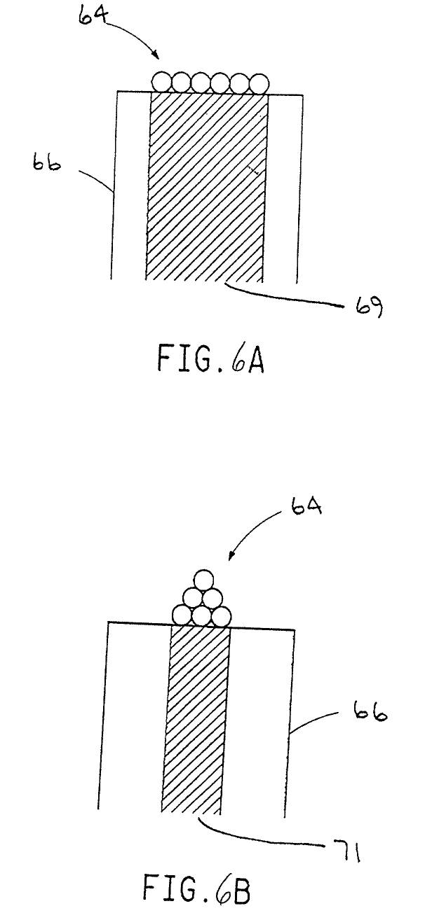

In the case of inspection of moving yarns for degree of interlace, the filaments of highly interlaced yarns will be bound together and the filaments of yarns without interlace will be spread out or splayed. This principle is illustrated in FIGS. 6A and 6B. FIG. 6A shows that, as a non-interlaced portion of a moving yarn 64 passes over the transparent wear surface 66, the filaments are spread out and cover a relatively large surface area 69. The reflected radiation is thus relatively large. By contrast, as shown in FIG. 6B, when an interlaced portion of moving yarn 64 passes over the transparent wear surface 66, it is in the form of a tighter bundle, taking up less surface area, and thus capable of reflecting relatively less radiation 71.

Interlaced portions of yarn are known as nodes. The reflectance data are processed in terms of the frequency of nodal (less) reflectance over time. The interlace nodes per unit yarn length are then determined, once the yarn speed (distance per unit time) is entered into the computer or other data analysis device. An optimum range of interlace (nodes/meter, for example) is established for a yarn product, and the interlacing process can be controlled to yield a finished product within that range.

The sensor of the present invention may also include a mounting plate 52 for attaching the sensor to a spinning machine. The mounting plate includes a plurality of holes 67 which are drilled through plate 52. The holes are adapted to receive radiation transmitting cable 76, which is bifurcated as shown in FIG. 4, for transmitting radiation to and from the wear surface. Each hole is surrounded by an “O” ring 68. One hole is provided for each moving yarn to be measured.

The sensor of the present invention also includes a plurality of brackets 58 as shown in FIG. 2. The brackets are mounted on the front side of the mounting plate. Each pair of brackets 58 holds the ends of a grooved guide pin 62, which guides a respective moving yarn. As shown in FIG. 3, other brackets 60 are provided on the mounting plate between the pairs of brackets 58 and hold the ends of wear surface 66.

The sensor of the present invention also includes a hinge assembly mounted to the front of the mounting plate for holding a second pin. Such a hinge assembly is shown at 56 in FIG. 2, and holds a second pin 70. This pin 70, which is preferably ceramic, swings toward the moving yarns to keep the moving yarns in contact with the wear surface. Each moving yarn 64 is held against wear surface 66 by routine operating tension, and each yarn is guided by a groove 65 in grooved guide pins 62 and by a second pin 70, which is held against the moving yarns by tension provided by hinge assembly 56. In this way, the moving yarns continuously wipe wear surface 66 clean.

Alternate shapes for the wear surface are within the scope of the present invention. For instance, FIG. 5 shows another embodiment of the wear surface, especially suitable for single thread line position monitoring. This single position unit has a saddle-shaped transparent wear surface 66′ attached to the single end of bifurcated cable 76′ that, as described above, leads to and from the source/detector unit 94.

Moreover, other yarn parameters can be monitored by use of this invention as well. The amount of finish on a yarn can be determined in like manner by careful selection of the wavelength of the radiation and the type of detector chosen for the specific wavelength(s) of interest. Generally, for water-based finishes, the radiation and detector are selected to permit measurement of the amount of water on the yarn. Alternatively, by utilizing a spectrophotometer as the detector, the wavelengths of light reflected from a colored yarn can be measured and quantified. This permits on-line color measurement of a moving yarn.

Interlace is generally imparted to a moving yarn by means of an interlace jet, which forces air or other gas through the filaments in the yarn and entangles them to form a node. Generally the air pressure at the interlace jets needed to form tight nodes is dependent on the yarn count, which is determined by parameters such as the denier per filament, the total denier of the yarn, the cross-sectional shape of the filaments, and the like. The number of nodes per meter can be controlled by controlling the interlace jet air pressure. Generally, the higher the pressure, the greater the number of nodes per meter (npm), as shown in the Examples below. Typically the degree of interlacing has been measured off-line by a destructive method by inserting a pin into the yarn to be tested and noting the incidence of entanglement by the nodes.

Several experiments were performed to compare the inventive sensor and method with the off-line sensor and method, especially as the number of nodes per meter relates to differences in the interlace jet air pressure. By comparing repeated measurements of a standard yarn with yarn of known interlace degree by both methods, a factor was determined which could be used to convert directly the measurement of this invention to the same scale as the previously-used off-line measurement.

### EXAMPLE 1

### Comparison of On-line Interlace Measurement with Off-line Measurement

The interlace of a 3.38 denier-per-filament (dpf) yarn sample was measured by both off-line and on-line measurements. Eight yarn samples spun on the same day were measured by the off-line measurement, and an average of 20.0 npm was obtained using the off-line method described above. Using the sensor of this invention, the same yarn count was measured on-line (4 positions on the same spinning machine), with the average interlace measured to be 23.4 npm. This then yielded a factor 1.2 (23.4/20). The sensor of this invention used in this example was fitted with an optic fiber cable of thick cladded glass. The electro/optical components of the sensor included an infrared LED identified as Optek OP290A and a silicon phototransistor identified as Optek OP5731. The wear surface was a half-rod of sapphire supplied by Imetra, Inc.

### EXAMPLE 2

### Variation in Interlace Jet Air Pressure and Resulting Measured Interlace

Two different interlace jets were tested on the same spinning machine position using the sensor of this invention. Testing included varying the air pressure and monitoring the subsequent interlace that resulted. Good agreement was noted between the results for the two different jets.

| | |
|---|---|
| Test Jet #1 | Test Jet #2 |

| pos press | NPM | APV | pos press | NPM |
|---|---|---|---|---|
| 65 (std) | 24 | 300 | 65 | 21 |
| 50 | 22 | 280 | 50 | 19 |
| 40 | 20 | 260 | 40 | 17 |
| 30 | 18 | 240 | 30 | 15 |
| 20 | 10 | 200 | 20 | 9 |
| 10 | 8 | 276 | 10 | 7 |
| 0 | 7 | 290 | 0 | 6 |

### EXAMPLE 3

### Measurement of Water on Yarn

A sensor of this invention was used to determine the amount of water based finish on moving yarns. The components of the sensor system were the same as that described above except that the particular cable used in this sensor is made from high transmission glass, available from the Cuda Products Company. The amount of finish present on the yarn can be calculated from the data obtained, since the concentration of the finish in water is known.

In use of this sensor for water/finish detection, the yarn is illuminated with a white light (broad spectrum) and the reflected light response, in the 1.4 um range, where water absorbs the light, is monitored, thus detecting the level of moisture (water) on the yarn. The radiation source was a Gilway lamp part #4115-2a. The detector was a Hamamatsu GaInAs detector part #G3476-05 mated with an optical band pass filter from OFC Corporation part #N01445. The optical band pass filter had a pass band response centered at 1445 nm with a +/− 56 nm bandwidth.

The sensor was tested using textile yarn from a production area in an “off-line” mode. A yarn transport carried the yarn from a bobbin over the sapphire wear surface. The voltage output from the detector was monitored for moist moving yarn. Yarn with increased moisture caused an increased voltage output.

What is claimed is:

1. A process for monitoring a yarn parameter, comprising the steps of:
(a) transmitting radiation from a source to a wear surface transparent to the radiation;
(b) contacting the wear surface with a moving yarn to be monitored so that the yarn continuously wipes the wear surface;
(c) reflecting the radiation from the yarn to a detector; and
(d) processing the reflected radiation to monitor a desired yarn parameter.

2. The process of claim 1 wherein the radiation is transmitted from a source disposed remote from the wear surface and is reflected to a detector disposed remote from the wear surface.

3. The process of claim 1 wherein the yarn parameter is the degree of interlace.

4. The process of claim 1 wherein the yarn parameter is the finish level of the yarn.

5. A sensor for monitoring a yarn parameter, comprising:
(a) a radiation source for transmitting radiation;
(b) a radiation transparent wear surface for receiving a moving yarn at which radiation is directed from the radiation source and from which radiation is reflected; and
(c) a detector for receiving the reflected radiation.

6. The sensor of claim 5, further including:
(d) a mounting plate for attaching the detector to a spinning machine;
(e) a plurality of brackets, mounted on the mounting plate, each bracket holding a first guide pin for guiding a moving yarn; and
(f) a hinge assembly mounted to the mounting plate for holding a second guide pin, wherein the second guide pin swings toward the moving yarn to keep the moving yarn in contact with the wear surface.

7. The sensor of claim 5 wherein the radiation source and the detector are located on the same side of the moving yarn.

8. The sensor of claim 5 wherein the radiation source and the detector are disposed remote from the wear surface.

9. The sensor of claim 5 wherein the wear surface is a sapphire rod.

10. The sensor of claim 5, further including a bifurcated cable including a first fiber optic bundle connected to the radiation source for transmitting radiation from the radiation source to the wear surface, and a second fiber optic bundle connected to the detector for transmitting the reflected radiation from the wear surface to the detector.
